(19) United States
(12) Patent Application Publication
(10) Pub. No.: US 2007/0156413 A1
(43) Pub. Date: Jul. 5, 2007

(54) IMS gateway systems and methods that provide session status checking

(75) Inventors: Yigang Cai, Naperville, IL (US); Xiangyang Li, Beijing (CN); Jie Su, Beijing (CN); Peng Wang, Beijing (CN); Jay Z. Zhao, Beijing (CN)

Correspondence Address: DUFT BORNSEN & FISHMAN, LLP, 1526 SPRUCE STREET, SUITE 302, BOULDER, CO, 80302, US

(73) Assignee: Lucent Technologies Inc.

(21) Appl. No.: 11/298,135

(22) Filed: Dec. 9, 2005

(30) Foreign Application Priority Data
Nov. 9, 2005 (CN) 200510124612.2

(51) Int. Cl. G06Q 99/00; G06Q 40/00

(52) U.S. Cl. 705/1; 705/35

(57) ABSTRACT

IMS gateway systems and methods are disclosed for providing mid-session status checking in an IMS network. An IMS gateway system described herein includes a budget control system and a status checking system. When a session has been established in the IMS network, the budget control system performs budget control for the session. Concurrently, the status checking system periodically checks the status of the session. Responsive to the status checking system determining that the session is active, the budget control system continues to perform the budget control for the session. Responsive to the status checking system determining that the session has terminated, the budget control system terminates the budget control for the session. By periodically checking the status of the session, the IMS gateway system advantageously avoids a runaway changing scenario in the IMS network.

### RELATED APPLICATIONS

This patent application claims priority to a foreign patent application filed in the Chinese Patent Office, having the application number 200510124612.2 and filed on Nov. 9, 2005.

### BACKGROUND OF THE INVENTION

1. Field of the Invention

The invention is related to the field of communications, and in particular, to IMS gateway systems and methods that provide mid-session status checking in IMS networks so that billing for the session does not continue after a session has been terminated.

2. Statement of the Problem

As set forth in the 3^{rd} Generation Partnership Project (3GPP), an IP Multimedia Subsystem (IMS) provides a common core network having access-agnostic network architecture for converged networks. Service providers are accepting this architecture in next generation network evolution. The IMS architecture is initially defined by the 3GPP to provide multimedia services to mobile subscribers over an IP network. IP networks have become the most cost savings bearer network to transmit video, voice, and data. IMS uses the advantage of IP networks to provide multimedia services for IMS subscribers on an IMS platform. The signaling used within IMS networks is SIP protocol. IMS defines the standard SIP interface between application servers, the IMS core network (CSCF), the IMS subscriber, the IMS database (HSS), and IMS billing elements. These standards can reduce the network integration costs and let the subscriber enjoy more stable services.

On the IMS platform, the traditional supplementary services, such as call forwarding, conferencing, and call waiting could be available for IMS subscribers. Also, many new data services, such as instant messaging, video calls, video on wait, and web-based services, will also be available for the IMS subscribers.

Providing efficient IMS online charging for operator revenue generation is important to the successful deployment of IMS networks. Several 3GPP technical specifications describe online charging for IMS networks. For instance, the 3GPP TS 32.200 specification describes an online charging system (OCS) having a session-based charging function. The OCS is coupled to a serving-call session control function (S-CSCF) through an IMS service control (ISC) interface. The S-CSCF controls a call session for a calling party or a called party and needs to communicate with the OCS over the ISC interface to provide online charging for the call session. However, an ISC interface is a service interface that does not support online charging. Therefore, in order to use the ISC interface between the S-CSCF and the OCS for online charging, additional functionality would unfortunately need to be added to the OCS.

In order to avoid overloading the OCS with additional functionality and to keep the online charging architecture consistent, the interface between the S-CSCF and the OCS may be changed to support online charging instead of adding functionality to the OCS. One option for an interface that supports online charging is to extend the ISC interface to allow for charging mechanisms. The ISC interface would then be both a service interface and a charging interface. Unfortunately, using the ISC interface as a hybrid service/charging interface may not be acceptable for standardization desired by the 3GPP.

Another option is to use the Ro interface instead of the ISC interface because the Ro interface already supports online charging. The 3GPP TS 32.296 specification suggests using the Ro interface for online charging by introducing an IMS gateway function that acts as a gateway between the S-CSCF and the OCS.

FIG. 1 illustrates the 3GPP online charging architecture 100 including the IMS gateway function 102 in the prior art. Online charging architecture 100 is described in 3GPP TS 32.240 and 32.260. Online charging architecture 100 includes IMS gateway function 102, a S-CSCF 104, and an OCS 106. OCS 106 includes a session-based charging function (SBCF) and an event-based charging function (EBCF). The session-based charging function is responsible for online charging of network/subscriber sessions, such as voice calls GPRS PDP contexts or IMS sessions. The event-based charging function performs event-based online charging (also referred to as “context charging”) in conjunction with any application servers.

The IMS gateway function 102 communicates with the S-CSCF 104 over the ISC interface 105 and communicates with the OCS 106 over the Ro interface 107. For online charging communication between the S-CSCF 104 and the session-based charging function in OCS 106, the S-CSCF 104 does not trigger online charging events and thus does not include a Charging Trigger Function (CTF). Instead, the ISC interface 105 is employed by the S-CSCF 104, implying that online charging is transparent to the S-CSCF 104 and appears like any other service controlled by a SIP application server. Therefore, if support for Ro-based online charging is required, a special CTF is needed in order to mediate between the Ro-based session-based charging function and the SIP-based service control. This role is taken by the IMS gateway function 102, which translates between SIP service control towards the S-CSCF 104 and the Ro credit control towards the OCS 106.

Unfortunately, the 3GPP specifications do not describe how to use the IMS gateway function 102 for online charging. For instance, the specifications do not define how the IMS gateway function 102 is to operate to provide online charging. The specifications also do not resolve how the ISC interface 105, the Ro interface 107, and the S-CSCF 104 would function together. For instance, the specifications state that whether the S-CSCF 104 is directly connected to the OCS 106 via a gateway (IMS gateway function) is beyond the scope of the standardization. Also, the physical position of the IMS gateway function 102 is in confusion in the specifications.

ISC interface 105 as defined by the 3GPP is based on the SIP interface, which mainly defines the session control messages during setup and tear down of the SIP-controlled session. When a session is established through S-CSCF 104, S-CSCF 104 communicates with IMS gateway function 102 to provide billing for the session. IMS gateway function 102 transmits a Credit Control Request (CCR) message of Ro interface 107 to the OCS 106 to provide online charging for the session. OCS 106 responds with a Credit Control Answer (CCA) indicating an allocated quota of units for the session. IMS gateway function 102 then performs budget control for the session based on the allocated quota of units. IMS gateway function 102 only maintains the ISC SIP call status during the session to support call control, but does not further control the session if there are enough quotas to maintain the session.

It is a problem in the current standards that the IMS gateway function 102 may not be notified that a session has ended. A session may end due to various reasons, such as system overload, system crash, system memory leak, etc. As an example, an IMS subscriber may request to view a 2 hour movie over the Internet. During the 2 hour period, the network congestion or other problems may cause the session to end prematurely. S-CSCF 104 may not notify IMS gateway function 102 of the session termination. Without being notified, IMS gateway function 102 continues to perform the budget control function until the subscriber's account runs out. When the account runs out, IMS gateway function 102 sends a SIP BYE message to S-CSCF 104 to end the session. However, the session was previously ended without IMS gateway function 102 being notified. This unfortunately results in a runaway charging scenario.

FIG. 2 is a message diagram illustrating a runaway charging scenario in the prior art. A session is first established through S-CSCF 104. S-CSCF 104 notifies IMS gateway function (IMS GW) 102 of a session being established. IMS gateway function 102 then requests a quota allocation from OCS 106 as described above and performs budget control. At some point, the session is terminated and S-CSCF 104 does not notify IMS gateway function 102 of the session termination.

During budget control, IMS gateway function 102 determines that the allocated quota has been used up, and requests a new quota from OCS 106. Once again, the session has ended, but IMS gateway function 102 unfortunately continues to perform budget control. Eventually, the subscriber's account in OCS 106 runs out and it will not allocate any more quotas to IMS gateway function 102 for the session. IMS gateway function 102 then transmits messages to terminate the session even though it has previously terminated.

It would be desirable to avoid the runaway charging scenario in IMS networks.

### SUMMARY OF THE SOLUTION

The invention solves the above and other related problems by defining systems and methods whereby an IMS gateway system periodically checks the status of a session in an IMS network. If a session has terminated without IMS gateway system being notified via messages, then the IMS gateway system will determine that the session has ended through a session status check. If the session status check indicates that the session has ended, then the IMS gateway system terminates budget control for the session. The session status check by the IMS gateway system advantageously avoids the runaway changing scenario in IMS networks.

One embodiment of the invention comprises an IMS gateway system of an IMS network that provides advantages over prior IMS gateway systems. The IMS gateway system includes a control system, a first interface for communicating with a serving-call session control function (S-CSCF), and a second interface for communicating with an online charging system (OCS). The control system includes a budget control system and a status checking system. When a session has been established in the IMS network, the budget control system performs budget control for the session. Concurrently, the status checking system periodically checks the status of the session. The status checking system may check the status of the session by communicating with the S-CSCF. For instance, the status checking system may periodically generate a status request message and transmit the status request message to the S-CSCF. If the status checking system receives a status response message from the S-CSCF, then the status checking system may determine that the session is active. If the status checking system does not receive a status response message from the S-CSCF within a threshold time period, then the status checking system may determine that the session has been terminated.

Responsive to the status checking system determining that the session is active, the budget control system continues to perform budget control for the session. Responsive to the status checking system determining that the session has terminated, the budget control system terminates the budget control for the session. By periodically checking the status of the session, the IMS gateway system advantageously avoids a runaway changing scenario in the IMS network.

Another embodiment of the invention comprises an associated method of operating an IMS gateway network. The invention may include other exemplary embodiments described below.

### DESCRIPTION OF THE DRAWINGS

The same reference number represents the same element on all drawings.

FIG. 1 illustrates the 3GPP online charging architecture including the IMS gateway function in the prior art.

FIG. 2 is a message diagram illustrating a runaway charging scenario in the prior art.

FIG. 3 illustrates an IP Multimedia Subsystem (IMS) network in an exemplary embodiment of the invention.

FIG. 4 is a flow chart illustrating a method of operating an IMS gateway system in an exemplary embodiment of the invention.

FIG. 5 is a state machine illustrating an exemplary operation of status checking system in an exemplary embodiment of the invention.

FIGS. 6-7 are message diagrams illustrating exemplary operations of an IMS network.

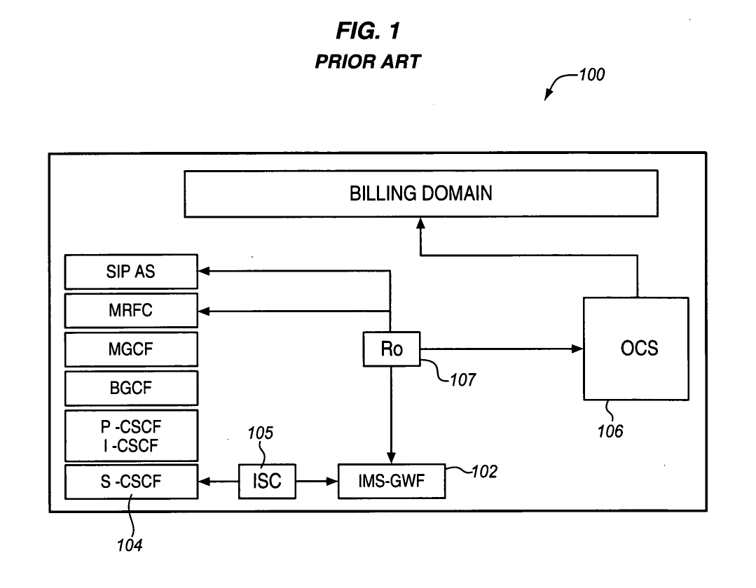

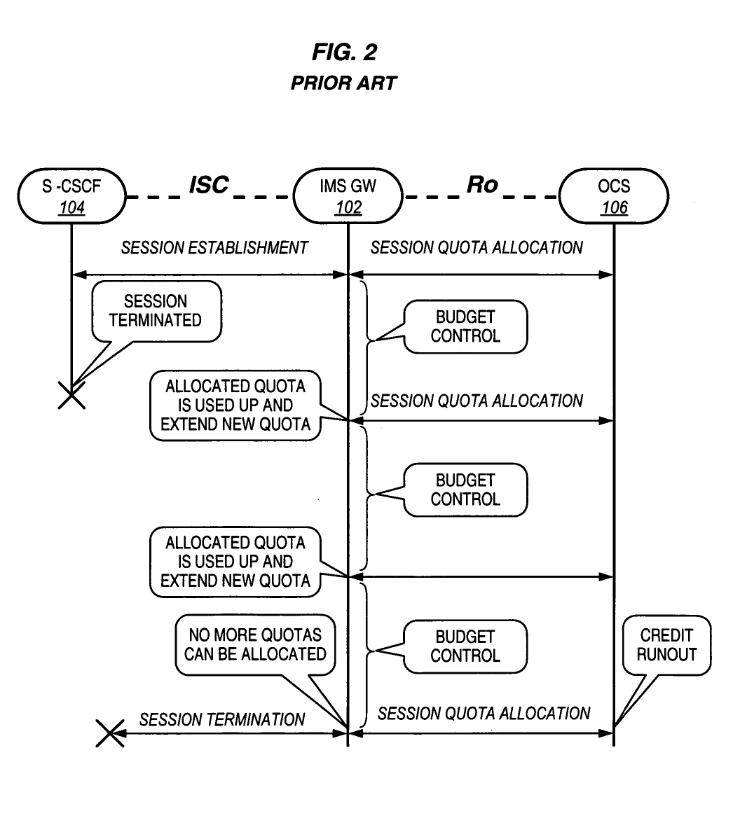

### DETAILED DESCRIPTION OF THE INVENTION

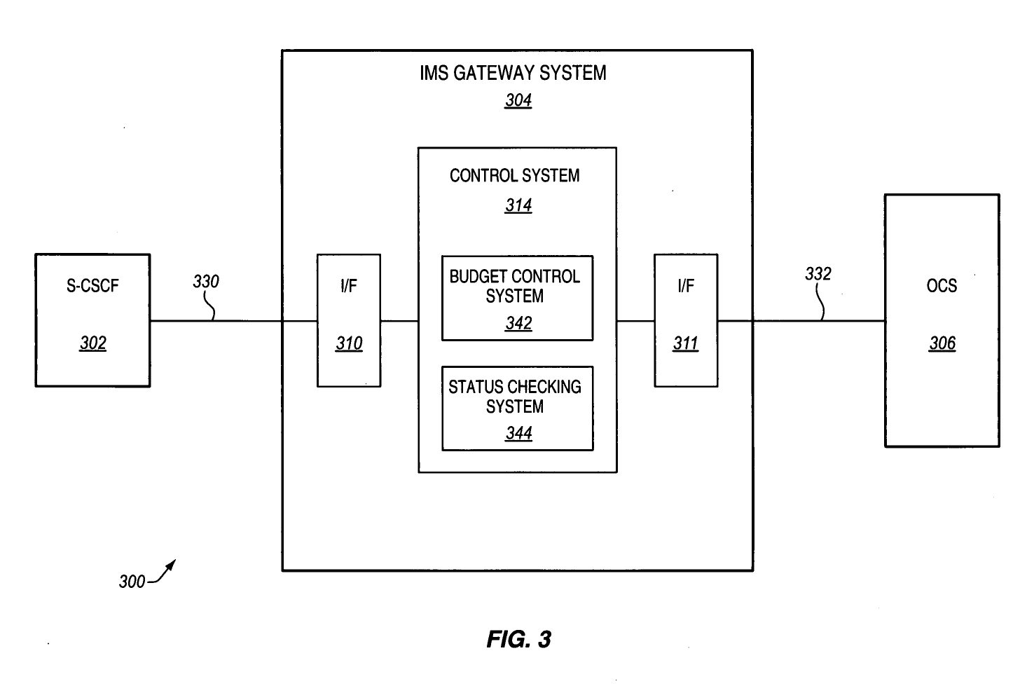

FIGS. 3-7 and the following description depict specific exemplary embodiments of the invention to teach those skilled in the art how to make and use the invention. For the purpose of teaching inventive principles, some conventional aspects of the invention have been simplified or omitted. Those skilled in the art will appreciate variations from these embodiments that fall within the scope of the invention. Those skilled in the art will appreciate that the features described below can be combined in various ways to form multiple variations of the invention. As a result, the invention is not limited to the specific embodiments described below, but only by the claims and their equivalents.

FIG. 3 illustrates an IP Multimedia Subsystem (IMS) network 300 in an exemplary embodiment of the invention. IMS network 300 includes a serving-call session control function (S-CSCF) 302, an IMS gateway system 304, an online charging system (OCS) 306. IMS gateway system 304 includes an interface 310 for communicating with S-CSCF 302, an interface 311 for communicating with OCS 306, and a control system 314. Interface 310 is coupled to S-CSCF 110 over a link 330 and communicates according to a protocol, such as the IMS service control (ISC) protocol. Interface 311 is coupled to OCS 306 over link 332 and communicates according to a protocol, such as the Ro protocol. Control system 314 includes a budget control system 342 and a status checking system 344. Control system 314 may comprise a processing system with associated storage media or any other desired architecture. IMS network 300 may include other components, devices, or systems not shown in FIG. 3 for the sake of brevity.

Budget control system 342 comprises any system, device, hardware, or software adapted to perform budget control for a session. Budget control comprises any charging functionality used for charging for a session, such as by communicating with an online charging system. The budget control may be for online charging typically used for prepaid applications. Status checking system 344 comprises any system, device, hardware, or software adapted to check the status of a session to determine whether a status is still active or has terminated.

Budget control system 342 and status checking system 344 may be implemented as software, hardware, or a combination of hardware and software. In a software implementation, budget control system 342 and status checking system 344 may be comprised of instructions that are stored on storage media. The instructions may be retrieved and executed by a processing system. Some examples of instructions are software, program code, and firmware. Some examples of storage media are memory devices, tape, disks, integrated circuits, and servers. The instructions are operational when executed by the processing system to direct the processing system to operate in accord with the invention. The term “processing system” refers to a single processing device or a group of inter-operational processing devices. Some examples of processors are computers, integrated circuits, and logic circuitry. Those skilled in the art are familiar with instructions, processors, and storage media.

When in operation, assume that a session has been initiated in IMS network 300 between devices that are not shown. Further assume that S-CSCF 302 is handling the session, such as providing call control. When the session is initiated, S-CSCF 302 transmits a message to IMS gateway system 304 indicating that the session has been established.

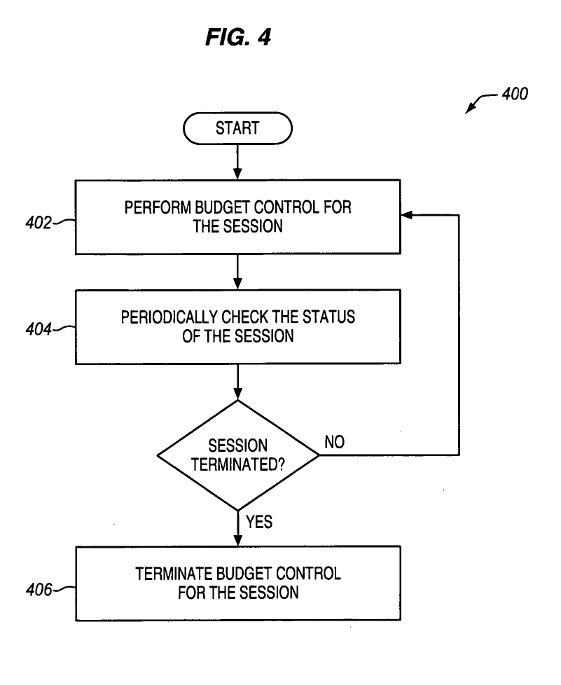

FIG. 4 is a flow chart illustrating a method 400 of operating IMS gateway system 304 in an exemplary embodiment of the invention. Responsive the session being established, budget control system 342 performs budget control for the session in step 402. For instance, as part of budget control, budget control system 342 may transmit a credit control request or similar message to OCS 306 to request a quota for the session. Budget control system 342 may receive a credit control answer or similar message indicating a quota allocated for the session. Budget control system 342 then begins decrementing from the quota based on usage for the session. If the allocated quota is used up, budget control system 342 may request a new quota from OCS 306.

Concurrently, status checking system 344 periodically checks the status of the session in step 404. The interval (referred to herein as the status checking interval) to “periodically” check the status of the session may vary depending on desired implementations. The status checking interval may be pre-defined or standardized for the status checking system 344. The status checking interval may alternatively be dynamic and may depend on the length of the session, the type of session (e.g., a voice call, a video download, an interactive video game, etc), or another variable. The status checking interval may change during a session.

Status checking system 344 actively checks the status of the session, such as by initiating communication with S-CSCF 302. For instance, status checking system 344 may periodically generate a status request message and transmit the status request message to the S-CSCF 302. If status checking system 344 receives a status response message from S-CSCF 302, then status checking system 344 may determine that the session is active. If status checking system 344 does not receive a status response message from S-CSCF 302 within a threshold time period, then status checking system 344 may determine that the session has been terminated.

Responsive to status checking system 344 determining that the session is active, budget control system 342 continues to perform the budget control for the session.

Responsive to status checking system 344 determining that the session has terminated, budget control system 342 terminates the budget control for the session in step 406. Terminating budget control in this embodiment means that budget control system 342 initiates a process to stop billing an IMS subscriber for the session.

The session status check periodically performed by status checking system 344 allows status checking system 344 to recognize when a session has been terminated even when IMS gateway system 304 has not been notified of the session termination. Budget control system 342 may then stop performing budget control for the terminated session. Such functionality advantageously avoids a runaway changing scenario in IMS network 300.

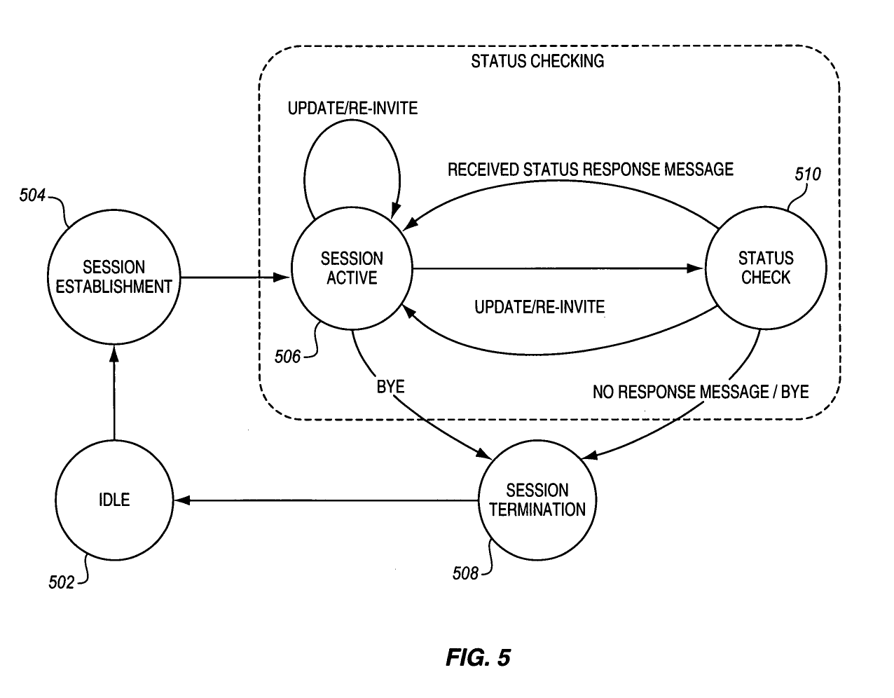

FIG. 5 is a state machine illustrating an exemplary operation of status checking system 344 in an exemplary embodiment of the invention. The state machine in FIG. 5 is just one example, and status checking system 344 may operate differently in other embodiments.

When a session has not been established, status checking system 344 is in an idle state 502. When a session is established, status checking system 344 moves to a session establishment state 504, and then to a session active state 506. Status checking system 344 sets a time stamp based on the time status checking system 344 enters the session active state 506. During the session active state 506, if status checking system 344 receives any mid-session message from S-CSCF 302, such as a SIP UPDATE message or SIP RE-INVITE message, then status checking system 344 knows that the session is still active. Status checking system 344 thus stays in the status active state 506. Status checking system 344 resets the time stamp based on the time the message was received.

If status checking system 344 receives a termination message from S-CSCF 302, such as a SIP BYE message, then status checking system 344 moves to a session termination state 508.

When in the session active state 506, status checking system 344 monitors a timer status checking system 344 is programmed to periodically check the status of the current session according to a status checking interval. The status checking interval defines when or how often the status of the current session is checked.

When status checking interval has been reached in the session active state 506, status checking system 344 moves to the status check state 510. The status checking interval comprises any desired interval between status checks. In the status check state 510, status checking system 344 transmits a status request message, such as a SIP INFO message, to S-CSCF 302. If status checking system 344 receives a status response message, such as a SIP OK message, from S-CSCF 302, then status checking system 344 moves back to the session active state 506. If status checking system 344 receives no status response message or receives an error message from S-CSCF 302, then status checking system 344 determines that the session has terminated. Status checking system 344 then tears down the current session and moves to the session termination state 508.

During the status check state 510, if any SIP message is received while status checking system 344 is transmitting the status request message, then status checking system 344 handles the received message. If the received message is a SIP BYE message, then status checking system 344 moves to the session termination state 508. If the received message is a mid-session signaling message, such as a SIP RE-INVITE or SIP UPDATE message, then status checking system 344 determines that the session is still active and moves to the session active state 506.

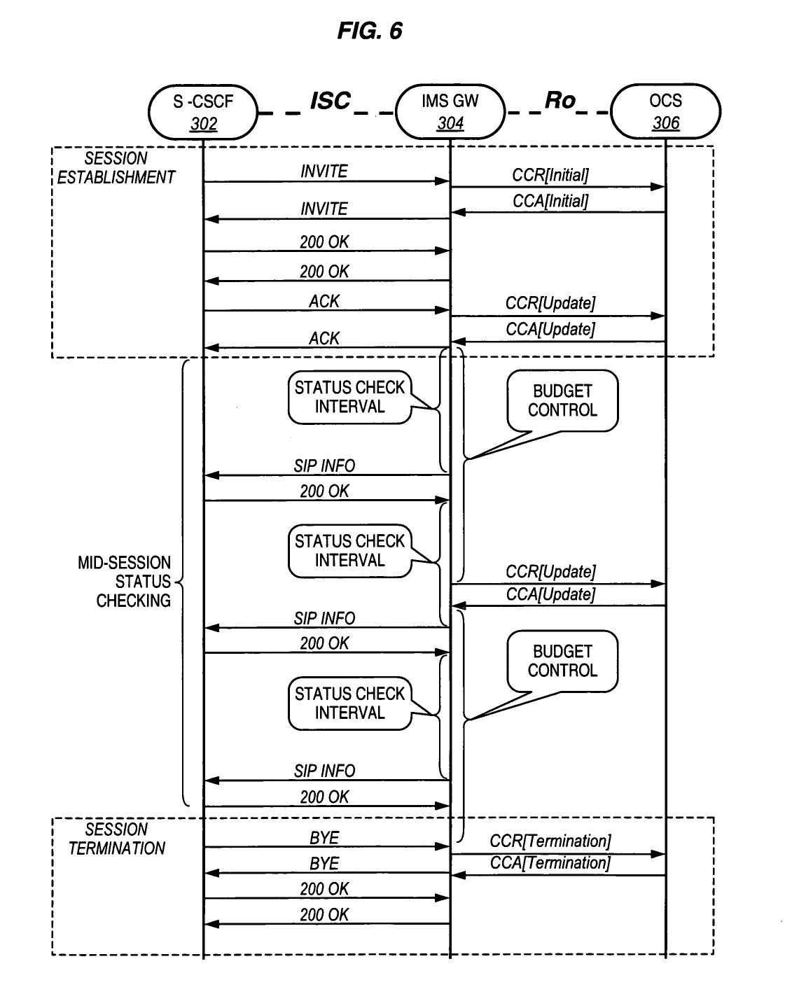

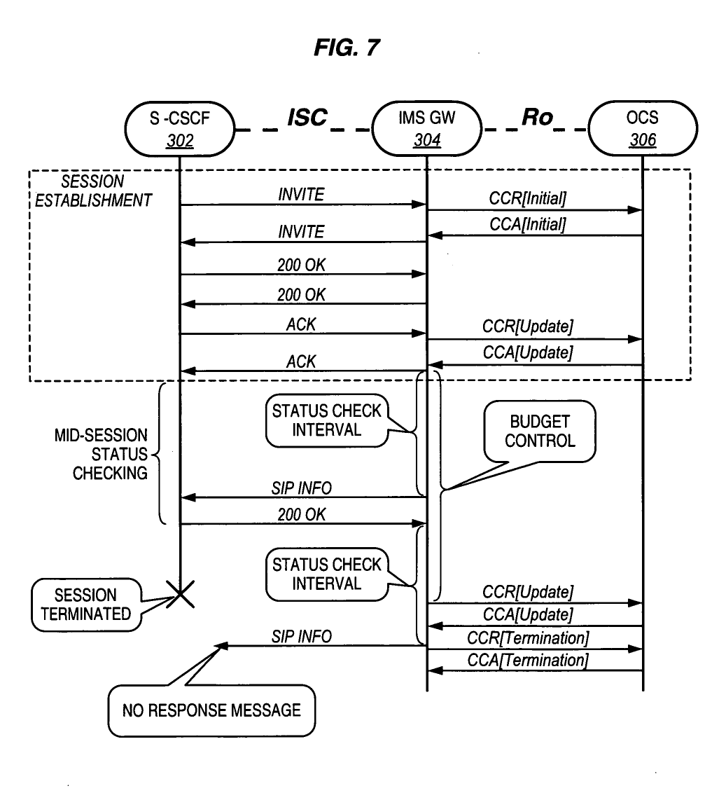

FIGS. 6-7 are message diagrams illustrating exemplary operations of IMS network 300. In FIG. 6, a session is properly ended and IMS gateway system 304 is notified of the session being terminated. In FIG. 7, a session is ended but IMS gateway system 304 is not notified of the session being terminated.

Referring to FIG. 6, to initiate the session, S-CSCF 302 transmits a SIP INVITE message to IMS gateway system 304. Budget control system 342 in IMS gateway system 304 transmits a CCR[Initial] message to OCS 306 to request a quota for the session from OCS 306. OCS 306 responds with a CCA[Initial] message indicating the quota allocated for the session. IMS gateway system 304 then transmits a SIP INVITE message to S-CSCF 302. S-CSCF 302 transmits a SIP 200 OK message to IMS gateway system 304, and IMS gateway system 304 responds with a SIP 200 OK message. S-CSCF 302 transmits a SIP ACK message to IMS gateway system 304, and IMS gateway system 304 responds with a SIP ACK message. Budget control system 342 transmits a CCR[Update] message to OCS 306, and OCS 306 responds with a CCA[Update] message. The session is thus established.

Budget control system 342 then performs budget control by monitoring the quota allocated for the session. Concurrently, status checking system 344 performs mid-session status checking. When the session is established, status checking system 344 sets a timer and defines a status checking interval. When the status checking interval has been reached, status checking system 344 transmits a SIP INFO message to S-CSCF 302. A SIP INFO message is not used to change the state of SIP sessions, or the parameters of the sessions. Status checking system 344 merely sends optional application layer information to S-CSCF 302 that is generally related to the session. Because the relationship between S-CSCF 302 and IMS gateway system 304 still exists, S-CSCF 302 responds to the SIP INFO message with a SIP 200 OK message. Status checking system 344 determines that the session is still active, and budget control system 342 continues to perform budget control.

Budget control system 342 also monitors quota consumption for the session. If the allocated quota from OCS 306 runs out, then budget control system 342 transmits a CCR[Update] message to OCS 306 to request a new quota. OCS 306 responds with a CCA[Update] message allocating the new quota to maintain the session.

When the status checking interval has been reached again, status checking system 344 transmits a SIP INFO message to S-CSCF 302. Because the relationship between S-CSCF 302 and IMS gateway system 304 still exists, S-CSCF 302 responds to the SIP INFO message with a SIP 200 OK message. Status checking system 344 determines that the session is still active, and budget control system 342 continues to perform budget control. Mid-session status checking continues as described above until IMS gateway system 304 receives a SIP BYE message from S-CSCF 302. Responsive to the BYE message, IMS gateway system 304 transmits a BYE message to S-CSCF 302 to terminate the session. Budget control system 342 also transmits a CCR[Terminate] message to OCS 306 to debit the session charge from the subscriber's account balance. OCS 306 responds with a CCA[Terminate] message.

The operation in FIG. 7 is substantially the same as FIG. 6 to establish a session. Budget control system 342 performs budget control by monitoring the quota allocated for the session. Concurrently, status checking system 344 performs mid-session status checking. When the session is established, status checking system 344 sets a timer and defines a status checking interval. When the status checking interval has been reached, status checking system 344 transmits a SIP INFO message to S-CSCF 302. Because the relationship between S-CSCF 302 and IMS gateway system 304 still exists at this time, S-CSCF 302 responds to the SIP INFO message with a SIP 200 OK message. Status checking system 344 determines that the session is still active, and budget control system 342 continues to perform budget control.

When the status checking interval has been reached again, status checking system 344 transmits a SIP INFO message to S-CSCF 302. The session has been terminated during the last status checking interval. Because the session has terminated, S-CSCF 302 is not able to respond to the SIP INFO message. When status checking system 344 does not receive a response to the SIP INFO message within a defined time period, status checking system 344 determines that the session has terminated.

Budget control system 342 then transmits a CCR[Terminate] message to OCS 306. OCS 306 responds with a CCA[Terminate] message. This messaging stops billing an IMS subscriber for the session that has been terminated. IMS gateway system 304 has advantageously avoided a runaway charging scenario by performing mid-session status checking to identify when a session has terminated.

Although specific embodiments were described herein, the scope of the invention is not limited to those specific embodiments. The scope of the invention is defined by the following claims and any equivalents thereof.

We claim:

1. An IP Multimedia Subsystem (IMS) gateway system for providing online charging for a session in an IMS network, the IMS gateway system adapted to communicate with a serving-call session control function (S-CSCF) for the session and an Online Charging System (OCS), the IMS gateway system comprising:
a budget control system adapted to perform budget control for the session; and
a status checking system adapted to periodically check the status of the session to determine if a session has been terminated;
the budget control system is adapted to terminate the budget control for the session responsive to the status checking system determining that the session has terminated.

2. The IMS gateway system of claim 1 wherein the budget control system is adapted to continue to perform the budget control for the session responsive to the status checking system determining that the session is active.

3. The IMS gateway system of claim 1 wherein the status checking system periodically checks the status of the session by being adapted to:
periodically generate a status request message and transmit the status request message to the S-CSCF.

4. The IMS gateway system of claim 3 wherein the status request message comprises a SIP INFO message.

5. The IMS gateway system of claim 3 wherein the status checking system determines that the session is active responsive to receiving a status response message from the S-CSCF.

6. The IMS gateway system of claim 5 wherein the status response message comprises a SIP OK message.

7. The IMS gateway system of claim 5 wherein the status checking system determines that the session has terminated responsive to not receiving a status response message from the S-CSCF within a threshold time period.

8. The IMS gateway system of claim 1 wherein the budget control system terminates the budget control for the session by being adapted to:
transmit a credit control request termination message to the OCS.

9. A method of operating an IP Multimedia Subsystem (IMS) gateway system for providing online charging in an IMS network, the IMS gateway system adapted to communicate with a serving-call session control function (S-CSCF) for the session and an Online Charging System (OCS), the method comprising:
performing budget control for the session;
periodically checking the status of the session to determine if a session has been terminated; and
terminating the budget control for the session responsive to determining that the session has terminated.

10. The method of claim 9 further comprising:
continuing budget control for the session responsive to determining that the session is active.

11. The method of claim 9 wherein periodically checking the status of the session comprises:
periodically generating a status request message; and
transmitting the status request message to the S-CSCF.

12. The method of claim 11 wherein the status request message comprises a SIP INFO message.

13. The method of claim 11 further comprising:
determining that the session is active responsive to receiving a status response message from the S-CSCF.

14. The method of claim 13 wherein the status response message comprises a SIP OK message.

15. The method of claim 13 wherein determining that the session has terminated comprises:
not receiving a status response message from the S-CSCF within a threshold time period.

16. The method of claim 9 wherein terminating the budget control for the session comprises:
transmitting a credit control request termination message to the OCS.

17. An IP Multimedia Subsystem (IMS) network, comprising:
a serving-call session control function (S-CSCF) adapted to serve a session in the IMS network;
an online charging system (OCS) adapted to provide billing for the session; and
an IMS gateway system adapted to communicate with the S-CSCF and the OCS to facilitate billing for the session, the IMS gateway system being adapted to:
perform budget control for the session;
periodically generate a status request message and transmit the status request message to the S-CSCF;
determine that the session has terminated responsive to not receiving a status response message from the S-CSCF within a threshold time period; and
terminate the budget control for the session responsive to determining that the session has terminated.

18. The IMS network of claim 17 wherein the IMS gateway system is further adapted to:
determine that the session is active responsive to receiving a status response message from the S-CSCF; and
continue to perform the budget control for the session responsive to determining that the session is active.

19. The IMS network of claim 18 wherein:
the status request message comprises a SIP INFO message; and
the status response message comprises a SIP OK message.

20. The IMS network of claim 17 wherein the IMS gateway system terminates the budget control for the session by being adapted to:
transmit a credit control request termination message to the OCS.
